(19) United States
(12) Patent Application Publication
(10) Pub. No.: US 2014/0361205 A1
(43) Pub. Date: Dec. 11, 2014

(54) Setting Screw Connection for a Hydraulic Valve, and Hydraulic Valve

(71) Applicant: Robert Bosch GmbH, Stuttgart (DE)

(72) Inventor: Lorenz Lippert, Gemuenden (DE)

(73) Assignee: Robert Bosch GmbH, Stuttgart (DE)

(21) Appl. No.: 14/268,338

(22) Filed: May 2, 2014

(30) Foreign Application Priority Data
Jun. 7, 2013 (DE) 10 2013 210 645.9

(51) Int. Cl. F16K 1/52; F16K 31/06; F16B 29/00

(52) U.S. Cl. CPC F16K 1/52; F16B 29/00; F16K 31/0655
USPC 251/112; 411/15

(57) ABSTRACT

A setting screw connection for a mechanically or electromagnetically actuable hydraulic valve has a setting region, a setting screw with an external thread, and a setting nut with an internal thread for mutual engagement. At least one of the internal thread and external thread has a cross section which differs from a circular shape. Further, at least one of the internal thread and external thread is configured to be predominantly elastically deformed via the engagement with the respectively other thread such that at least one of the setting screw is secured against rotation at least in the setting region, and an axial play of the setting screw is prevented at least in the setting region. A hydraulic valve includes the setting screw connection, and has a valve piston which is positioned axially displaceably and is coupled axially to the setting screw connection.

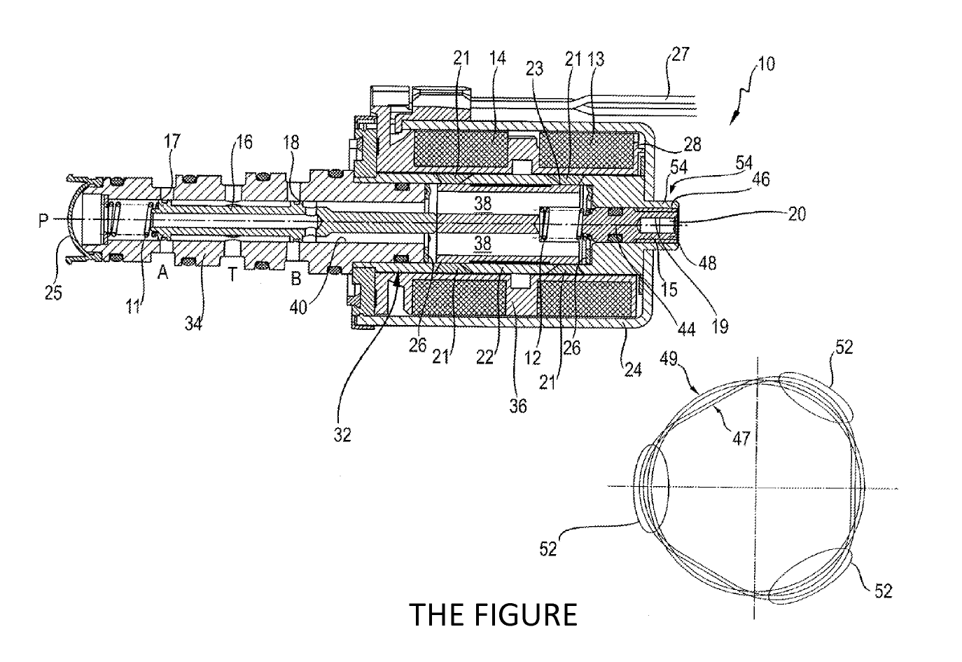

This application claims priority under 35 U.S.C. §119 to patent application no. DE 10 2013 210 645.9, filed on Jun. 7, 2013 in Germany, the disclosure of which is incorporated herein by reference in its entirety.

The disclosure relates to a setting screw connection for a hydraulic valve, and to a hydraulic valve.

### BACKGROUND

A hydraulic valve has a valve body or valve piston which is received axially displaceably in a housing and via the axial displacement of which a plurality of hydraulic connections of the valve can be brought into a pressure medium connection with one another or can be disconnected from one another. The object is set here, for example, of it being possible to set a neutral or basic position of the valve piston relative to the housing. This can take place, for example, via one spring which acts axially on the valve piston or via two springs which act axially on the valve piston in an opposed manner. Depending on their spring force and prestress, the piston assumes its basic position. In order for it to be possible to influence or adjust them, the prior art knows the possibility of a setting screw connection, via which a supporting face of the spring can be set variably in terms of its axial position, with the result that the prestress of the spring can be changed. This results in a changed basic position of the valve piston.

Here, the setting screw connection has a setting screw which is accessible from outside the housing with an external thread and a setting nut which is fixed to the housing with an internal thread. Here, the abovementioned spring, the prestress of which is to be changed, is supported on an inner end section of the setting nut. The challenge is naturally set for the setting screw connection of securing the setting screw against undesired adjustment, that is to say rotation in the circumferential direction or axial settling on account of an axial play, for example on account of vibrations, shaking or undesired intervention.

In conventional setting screw connections of hydraulic valves, this securing takes place via a sealing ring, in particular an O-ring, which is arranged radially circumferentially in a region of the setting screw, which region is not taken up by the external thread. Via the deformable sealing ring, the setting screw is supported radially against a part of the valve which is fixed to the housing, as a result of which a securing moment against rotation of the setting screw and a securing force against an axial adjustment in the context of an axial play result from an elastic deformation of the sealing ring.

The disadvantage of this solution is that the design of the sealing ring is difficult on account of its two functions which are to be fulfilled, sealing against leakage and securing against adjustment. In addition, a torque of the setting screw which is to be applied by an operator can fluctuate depending on whether or not the sealing ring is wetted with pressure medium, which impairs reproducibility of the setting. The sealing ring also cannot provide any securing against an axial adjustment in the context of the axial play, since its supporting forces are not sufficient for this purpose.

Further securing means which are known from the prior art, such as a securing ring or a toothed disk or the like, which represent an axial additional element, cannot be used in the setting screw connection, since they require an axial stop in order to build up a prestress. However, there is naturally no axial stop in the setting screw connection, at least in its setting region. Known radial additional elements, such as a binding thread, have the disadvantage that their behavior is temperature-dependent and medium-dependent, and that they can influence a radial central position of the setting screw in the nut. In addition, they represent a risk of contamination. The introduction of, for example, a micro-encapsulated adhesive between the setting screw and the setting nut also entails the disadvantage of temperature dependence and medium dependence and torque dependence of the behavior of said additional element. In addition, there is also the contamination problem and the influencing, caused by the adhesive, of the central position of the setting screw. The gravest problem, however, is that the adhesive does not make reusability or repeated adjustment of the setting screw possible. Securing means which are based on a plastic deformation of one or both threads have the disadvantages of a high setting torque, the pronounced formation of particles and the damage to surface protection. Subsequent radial or axial deformation of the nut or the setting screw from the outside, for example via center marks, or radial deformation from the inside also harbor the risk that the setting could be changed within an axial play of the two threads as a result of the subsequent deformation. In addition, they are not flexible.

### SUMMARY

In contrast, the disclosure is based on the object of providing a setting screw connection for a hydraulic valve, which setting screw connection provides securing of the setting screw against an adjustment in a relatively simple way in terms of device technology. It is the object, furthermore, to provide a valve having a setting screw connection of this type.

The first object is achieved by way of a setting screw connection, and the second object is achieved by way of a valve.

Advantageous developments of the disclosure are described in the patent claims.

A setting screw connection, in particular a self-securing leading screw connection, for a mechanically or electromechanically actuable hydraulic valve, in particular for setting an axial position of an axially displaceable valve piston or prestress of a spring which can be coupled, in particular is coupled, axially to the valve piston, has a setting region which is, in particular, axial and a setting screw with an external thread and a setting nut with an internal thread. In particular, the threads have an identical nominal diameter and an identical nominal lead. For setting purposes, the threads can be brought into engagement with one another. According to the disclosure, at least one of the threads (it can also be both threads) has a cross section which differs from a circular shape. In addition, via the engagement of the respectively other thread, at least one of the threads can be deformed predominantly elastically (in particular, largely predominantly) in such a way that the setting screw is secured against rotation at least in the setting region and/or that an axial play of the setting screw is prevented at least in the setting region.

In this way, the setting screw connection is secured in a self-locking and self-securing manner in a relatively simple way in terms of device technology, independently of an axial prestress, against an adjustment as a result of rotation and/or axial settling, with the result that no further apparatuses for securing against adjustment are necessary. On account of said elastic deformation, the setting screw connection is secured particularly satisfactorily against adjustment on account of vibrations or shaking. The setting screw and/or nut can thus be adjusted, re-adjusted, dismantled and reused repeatedly without a loss of their securing function. On account of said predominantly or largely predominantly elastic and therefore reversible deformation, the setting screw connection is subject to no wear or to scarcely any wear, with the result that it has a satisfactorily reproducible securing moment over a long time despite adjustments being performed. That is to say, it permits a multiplicity of adjusting operations with a constant securing moment and without appreciable wear. In addition, abrasion on the threads is minimized on account of the low wear. This is an important advantage in the use of the setting screw connection on a valve or in a hydraulic system, where wear particles can contribute to sometimes considerable disruptions or failures. On account of said elastic deformation, the setting screw connection can be operated in a very sensitive manner. If the deformation is such that the axial play is prevented, high setting accuracy and reproducibility of the value to be set via the setting screw of the axial position or spring prestress can be achieved. As a result, a play-free setting operation can end both in a rotation to the right and in a rotation to the left, since both thread flanks of one thread are in contact with both thread flanks of the other thread in the region of the elastic deformation. Axial settling phenomena on account of a flank diameter play are therefore ruled out. The flank diameter play of a standardized (DIN 13) threaded connection which has an order of magnitude of from approximately 2/100 to 25/100 mm results in a corresponding axial play. In order to generate a securing moment in the setting screw connection, the elastic component of the deformation, defined by a deviation from the circular shape, is preferably greater than a standardized, maximum play of the two flank diameters of the two thread partners.

If the setting screw has the cross section which differs from the circular shape, the elastic deformation can also migrate in the circumferential direction during an adjustment of the setting screw. There is partial or fully circumferential elastic deformation depending on a degree of the deviation from the circular shape.

In the context of this application, the expressions predominantly elastically deformable or largely predominantly elastically deformable are to be understood such that a plastic deformation is not ruled out, but its proportion in the entire deformation is low or very low, however, in favor of the elastic deformation. This low plastic component of the deformation has an effect merely during the first screwing-in operation, and merely the elastic component acts on the securing moment during the second screwing-in operation. The size ratios of plastic to elastic deformation are very dependent on wall thicknesses of the setting screw and the setting nut. The lower the plastic component in the deformation, the less the torque fluctuates between the first screwing-in operation and further screwing-in operations or between the first screwing-in operation and a screwing-out operation.

The elastic deformation preferably results from a radial prestress which acts on sections of thread flanks which are in contact with one another on a thread circumference.

In the context of this document, deviating from the circular shape means that the deviation lies outside a tolerance field of the flank diameter of a conventional, circular cross section, that is to say the cross section differs intentionally from the circular shape.

In one preferred development, the external thread has the cross section which differs from the circular shape and the internal thread has a circular cross section. In one preferred development which is an alternative to this, the internal thread has the cross section which differs from the circular shape and the external thread has the circular cross section. As an alternative to this, it is also conceivable that both threads have a cross section which differs from the circular shape.

In the context of this document, secured against rotation means that the setting screw can be released again or rotated only if an intended securing moment is exceeded.

The setting screw connection can be configured with or without an axial stop.

The threads are preferably configured as V-threads with a flank or V angle of 60°, but other thread shapes and angles which are known to a person skilled in the art are of course also possible.

A nominal diameter of the setting screw connection is preferably greater than or equal to M3 and less than or equal to M16, the disclosure not being restricted to said values.

Metallic or non-metallic materials can be used as material for the setting screw and the setting nut. It is also conceivable here to use different materials for the setting screw and the setting nut.

In particular, a radial play of the setting screw can be minimized via the elastic deformation of one or both threads, which increases the precision of the setting screw connection.

In one particularly preferred development, the respectively other thread has a substantially circular cross section. Advantageous here are its simple production and satisfactory reproducibility of the securing moment and its profile depending on an axial length of the engagement, or a screwing-in depth of the setting screw.

In one particularly preferred development, the cross section which differs from the circular shape is approximately that of a rounded polygon or approximately that of a curve of constant width which is, in particular, trilobular. Here, the cross section of a curve of constant width is to be understood to mean a curve which has a preferably odd number of circumferentially uniformly distributed curve regions with a smaller rounding radius. Opposite each of said curve regions, a curve region with a greater rounding radius is arranged. In the case of the polygon and in the case of the curve of constant width, both thread flanks of one thread are in contact with both thread flanks of the other thread, preferably in the curve regions which have the smaller rounding radius. In a deviation from a preferred basic shape having three rounded “corners”, the polygon or the curve of constant width can preferably have five or more “corners”, or curve regions of lesser rounding. In a deviation from the cross section which is a polygon or a curve of constant width, the cross section which differs from the circular shape can be of elliptical configuration.

In one particularly preferred development, tolerance zones of flank diameters of the external thread and the internal thread have a complete overlap in the radial direction. A distinction is to be made between two cases: if the cross section of the external thread differs from the circular shape and the internal thread has the circular cross section, the complete overlap exists if a minimum circumcircle flank diameter of the external thread is greater than a maximum flank diameter of the internal thread. In the other case, if the cross section of the internal thread differs from the circular shape and the external thread has the circular cross section, the complete overlap exists if a maximum in-circle flank diameter of the internal thread is smaller than a minimum flank diameter of the external thread. That is to say that there is an oversize in every case in the region of the overlap independently of the tolerance position, which oversize leads to the above-described elastic deformation during engagement. In the case of the polygon and in the case of the curve of constant width, the overlap of the tolerance zones is arranged in the region of their curve regions of smaller rounding (described further above) and migrates circumferentially together with the rotation of the setting screw, in the case of a deviation from the circular shape on the external thread.

In one particularly preferred development, the setting screw has at least one recess which extends substantially axially within its external thread and is delimited radially by a setting screw wall which can be deformed elastically via the engagement. Via said recess, the setting screw is weakened, in particular, radially in this region, with the result that it is less rigid at least radially in comparison with a solid body setting screw. In this development, in addition to the thread, the body of the setting screw can therefore also contribute to the provision of the necessary elastic deformation. It is advantageous here that the plastic component of the deformation, in particular of one or both threads, can thus be minimized yet further. The setting screw can therefore be adjusted as often as desired, without a decrease in frictional forces and a positively locking connection of the threads. Since the setting screw connection which is shown is not a fastening connection, the weakening which is introduced by way of the recess is not disadvantageous, since the screw only has to transmit relatively low forces. The at least one recess is preferably configured at least in sections via a substantially axial bore.

Here, a receptacle for a mounting tool, in particular for a screwdriver head, for example a Torx or Allen key or another polyhedron tool, is advantageously formed at least over an axial end section of the recess.

In one particularly preferred development, the setting nut has, in a region of its internal thread, a low radial wall thickness such that the wall of the setting nut can also be deformed largely predominantly elastically in engagement.

In accordance with the preceding text, the securing moment can be influenced by a clamping action which results from the elastic deformation and a resulting positively locking connection of the two threads, by the oversize and by the wall thickness of the setting nut wall. Here, an additional option is afforded by the variation of said wall thickness of the setting screw, or of the setting screw wall. Independently of this, the securing moment can of course be influenced by the materials which are selected for the setting screw and setting nut.

A hydraulic valve according to the disclosure has a valve housing with a valve bore, in which a valve piston, in particular a valve slide, is received axially displaceably at least in sections. In addition, it has a setting screw connection which is configured in accordance with one of the preceding aspects and to which the valve piston can be coupled at least in the axial direction. A valve of this type is disclosed, for example, in document DE 10 2011 005 356 A1 as a decoupling valve device of a hydraulic hybrid drive. Here, a hydrostatic accumulator can be disconnected fluidically from hydraulic machines of the drive via the valve or can be connected fluidically to them.

The setting screw connection which has already been described in detail results in the advantages which have already been described at length, in particular for the setting of an axial position of the valve piston, for which reason the repetition can be dispensed with at this point.

In one particularly preferred development of the valve, the setting screw of the setting screw connection is coupled to the valve piston via a spring, with the result that the valve piston can be loaded with a spring force which can be set via the setting screw. The spring can particularly preferably be coupled to an axial end section of the valve piston. Via the coupling, the valve piston can be prestressed into a basic position which is, for example, an end position or a center position. In the opposite axial direction, the valve piston can be loaded, for example, with a pressure medium, which results in its axial position via a force equilibrium which is set at the valve piston. As an alternative or in addition to this pressure medium loading, the valve piston can be coupled to another spring which counteracts the one spring, which results in a spring-centered basic position for the valve piston, which basic position can be changed via the setting screw.

The setting nut is preferably configured or arranged fixedly on the housing of the valve.

In one preferred development of the valve, it can be actuated electromagnetically and has an electromagnet, the setting nut of the setting screw connection being configured over a pole tube section of the electromagnet. As a result, the pole tube has multiple functionality and a component which has to be provided in addition for the setting nut can be saved. In this case, the setting screw can preferably be coupled via the spring and the latter via a magnet armature of the electromagnet to the valve piston.

In one preferred development of the valve, the pole tube section, or the setting nut, penetrates a housing of the electromagnet, with the result that, for example, the recess of the setting screw is readily accessible from the outside for an adjustment of the setting screw.

The external thread and the internal thread particularly preferably have approximately identical axial lengths, as a result of which the setting screw cannot protrude substantially beyond the setting nut, even if it is in complete engagement, and is thus protected satisfactorily against undesired rotation.

### BRIEF DESCRIPTION OF THE DRAWINGS

In the following text, one exemplary embodiment of a valve according to the disclosure having a setting screw connection according to the disclosure will be explained in greater detail in a drawing, in which:

The FIGURE shows one exemplary embodiment of a valve having a setting screw connection in a longitudinal section, and an illustration and tolerance zones of the setting screw connection.

### DETAILED DESCRIPTION

The FIGURE shows an electromagnetically actuable valve 10. The latter has a housing 24 made from a ferromagnetic material, in which components of an electromagnet are received. Furthermore, it has a power supply 27, with which a plug (not shown) of the valve is in contact. Two coils 13, 14 are arranged spaced apart from one another in the axial direction in the housing 24, which coils 13, 14 can be supplied with power via the plug.

On one end section of the housing 24 which is arranged on the left in The FIGURE, said housing 24 is penetrated by a fastening section 32 of a valve bushing 34. Here, the fastening section 32 is connected fixedly to a pole tube 22. A magnet armature 23 which has two axial and parallel through holes 38 is received axially displaceably in the pole tube 22. The pole tube 22 has two welds 21 which extend circumferentially approximately in the region of two end sections of the magnet armature 23 and are composed of non-magnetic material. Via the welds 21, the magnetic field lines can be diverted from the pole tube 22 of ferromagnetic configuration into the ferromagnetic magnet armature 23.

Furthermore, a coil former 28 which is composed of plastic is arranged in the housing 24, and coaxially with respect to the abovementioned components. Said coil former 28 supports the two coils 13, 14 radially circumferentially, which coils 13, 14 are separated from one another via a radially widened web 36 of the coil former 28, which web 36 is configured approximately axially centrally. Two recesses are made in the coil former web 36, into which recesses in each case one yoke plate (not shown) is inserted which closes the magnetic circuit from the pole tube 22 to the housing 24. The coil former 28 is seated with an inner circumferential face on an outer circumferential face of the pole tube 22.

The valve bushing 34 is configured as a plug-in or cartridge bushing, but, as an alternative, can also be configured as a screw-in bushing. It has a substantially circularly cylindrical outer contour. A through hole 40 is formed coaxially in the valve bushing 24, in which through hole 40 a valve piston 16 is received axially displaceably. The valve 10, or the valve bushing 34, has four connections: a pressure connection P, two working connections A, B and a tank connection T. Here, the pressure connection P is configured coaxially with respect to the through hole 40 on an end section of the valve bushing 34, which end section is arranged opposite the fastening section 32, and said pressure connection P opens into said through hole 40. The other connections A, B and T are arranged as radial star holes on discrete axial sections of the valve bushing. Here, the diameters of the axial sections decrease in a stepped manner from connection to connection in the insertion direction of the valve 10 (from the right to the left in The FIGURE).

The pressure connection P is protected against external contamination via a screen 25 which is pushed onto said end section of the valve bushing. A constant (that is to say, non-adjustable) spring 11 is arranged on said end section, via which spring 11 an end side of the valve piston 16 is loaded with a spring force in addition to a pressure force which results from the pressure which prevails at the pressure connection P.

On an opposite end side of the valve piston 16, the latter is supported on a web which is formed between the two through holes 38 of the magnet armature 23. An adjustable spring 12 is received at the other end section of the web in a blind hole which is formed in the magnet armature 23. A setting screw 44 dips with a tapered end section into its other end section which points toward the opening of the blind bore. Here, the setting screw 44 is guided with its end section which faces the magnet armature 23 in a through hole of the pole tube 22. At that end section of the setting screw 44 which is arranged remotely from the spring 12, said setting screw 44 has an external thread 46 which is in engagement with an internal thread 48 of a setting nut 50 which is formed by a section of the pole tube 22. Here, in order to form the setting nut 50, the section of the pole tube 22 is tapered radially to a pronounced extent in comparison with the rest of the pole tube. This greatly tapered section, or the setting nut 50, penetrates the housing 24 toward the outside.

In a region of the external thread 46, the setting screw 44 has a coaxially extending recess 19 which is configured as a bore. As a result, a setting screw wall 15 of low wall thickness is formed between the recess 19 and the external thread 46. In the direction of an outer side of the housing 24, the recess 19 merges into a receptacle 20 which is configured as a hexagon socket.

The further description concentrates on the representation of the setting screw connection according to the disclosure, the components of which are the setting screw 44 with the external thread 46 and the setting nut 50 with the internal thread 48. A more detailed description of the other components of the valve 10 will be dispensed with at this point, since valves of this type are sufficiently known from the prior art.

On the bottom at the right, The FIGURE diagrammatically shows tolerance zones 47 and 49, which are assigned to the external thread 46 and the internal thread 48, of a flank diameter of the respective thread 46, 48. Here, the tolerance zone extends parallel to the cross section of the associated thread. Here, the series of curves of the tolerance zone 47 corresponds to that of the external thread 46 and the series of curves of the tolerance zone 49 corresponds to that of the internal thread 48. It can be seen clearly that the internal thread 48 has a basically circularly cylindrical cross section, whereas the external thread 46 has a cross section which differs from the circular shape. According to the exemplary embodiment which is shown, this cross section is that of a trilobular curve of constant width. It can be seen clearly that the tolerance zones 47, 49 have regions of overlaps 52. These lie where the trilobular cross section has its “corners” with a smaller rounding radius. Between these, the cross section has curve regions with a great rounding radius, which approximates to the illustration of a straight line in The FIGURE for improved illustration of the tolerance zones. The overlaps 52 ensure that a predominantly or largely predominantly elastic deformation of the two threads 46, 48 can occur in each tolerance position.

It is associated with the elastic deformation in the radial direction that the setting nut 44 is secured against an undesired circumferential adjustment or rotation, for example on account of vibration or shaking, with a sufficient securing moment. Here, in the exemplary embodiment which is shown, the deformation during a first screwing-in operation is elastic and plastic over its entire setting region. From a first screwing-out operation, however, that is to say for all further setting operations, the securing moment results not only predominantly but rather exclusively from elastic deformation, however. This requirement is achieved to a lesser extent by way of the exemplary embodiment which is shown by virtue of the fact that the abovementioned recess 19 leads to a setting screw wall 15 with a low diameter, as a result of which the setting screw 44 is of less rigid configuration in the radial direction in this region. As a result, the necessary elastic deformation can also be provided by the setting screw wall 15, but mainly by the external thread 46. In addition, in the exemplary embodiment which is shown, mainly a setting nut wall 54 of the setting nut 50 is configured with a small wall thickness. The setting nut 50 therefore reacts, in addition to the elastic deformation of its internal thread 48, with an elastic deformation of the setting nut wall 54 to the oversize of the setting screw 44 which is present in the overlaps 52 with deformation. These measures ensure that plastic deformation takes place only during the first screwing-in operation and only slightly.

It is the case for the exemplary embodiment which is shown that a torque during the screwing in of the setting screw 44 (from the left to the right in The FIGURE) rises until all thread turns of the external thread 46 which have the cross section of the curve of constant width are in engagement with the internal thread 48. During further rotation, the torque remains uniformly high and is active at every angular position of the screw partners with respect to one another.

The threads 46, 48 can be formed and/or can be produced by machining. The machining of the external thread 46 can be produced, for example, by drilling, and the external thread 46 and the internal thread 48 can be produced by thread milling. The thread forming can take place by milling, rolling or straight out of the injection molding die. The necessary deviation from the circular shape can be produced by the production process of the thread or by a subsequent deformation of the thread.

The wall thickness of the setting screw wall 15 can be influenced by means of hollow drilling, in particular in the case of setting screws with a head, or by means of the introduced inner geometry by the tool engagement, in the case of screws without a head.

One particular advantage of the trilobular cross-sectional geometry is that a center axis position of the setting screw 44 remains oriented in a centered manner during the actuation, or during the turning. Alternative exemplary embodiments, in which the external or internal thread has a triangular polygonal cross section, also have the same advantage.

A setting screw connection is disclosed for a mechanically or electromagnetically actuable hydraulic valve, in particular for setting an axial position of a valve piston or prestress of a spring which can be coupled axially to the valve piston. To this end, the setting screw connection has a setting region and a setting screw with an external thread and a setting nut with an internal thread for mutual engagement. Here, at least one of the threads has a cross section which differs from a circular shape, it being possible, via the engagement, for at least one of the threads to be deformed predominantly elastically by the respectively other thread in such a way that the setting screw is secured against rotation at least in the setting region and/or an axial play of the setting screw is prevented at least in the setting region.

Furthermore, a hydraulic valve is disclosed having a setting screw connection of this type and having a valve piston which is arranged axially displaceably and can be coupled axially to the setting screw connection, in particular to the setting screw.

### LIST OF DESIGNATIONS

10 Valve
11, 12 Spring
13, 14 Coil
15 Setting screw wall
16 Valve piston
17, 18 Control collar
19, 20 Recess
21 Weld
22 Pole tube
23 Magnet armature
24 Housing
25 Screen
26 End stop
27 Power supply
28 Coil former
32 Fastening section
34 Valve bushing
38 Through hole
40 Through hole
44 Setting screw
46 External thread
47 Tolerance field
48 Internal thread
49 Tolerance field
50 Setting nut
52 Overlap
54 Setting nut wall

What is claimed is:

1. A setting screw connection for a mechanically or electromagnetically actuable hydraulic valve, comprising:
a setting region;
a setting screw that includes an external thread; and
a setting nut that includes an internal thread;
wherein the internal thread and external thread are configured to be brought into engagement with each other for setting purposes;
wherein at least one of the internal thread and external thread has a cross section which differs from a circular shape;
wherein at least one of the internal thread and external thread is configured to be predominantly elastically deformed via the engagement with the respectively other thread such that at least one of:
the setting screw is secured against rotation in at least the setting region; and
an axial play of the setting screw is prevented in at least the setting region.

2. The setting screw connection according to claim 1, wherein the respectively other thread has a substantially circular cross section.

3. The setting screw connection according to claim 1, wherein the cross section which differs from a circular shape has an approximate shape of a rounded polygon or a curve of constant width.

4. The setting screw connection according to claim 1, wherein tolerance zones of respective flank diameters of the external thread and the internal thread have at least one complete overlap in a radial direction.

5. The setting screw connection according to claim 1, wherein the setting screw includes at least one recess which extends substantially axially within the external thread and which is delimited radially by a setting screw wall that is configured to be elastically deformed via the engagement.

6. The setting screw connection according to claim 5, wherein:
the at least one recess includes a receptacle for a mounting tool; and
the receptacle is located over at least an axial end section of the at least one recess.

7. The setting screw connection according to claim 1, wherein the setting nut has, in a region of the internal thread, a setting screw wall having a low radial wall thickness such that the setting screw wall is configured to be predominantly elastically deformed via the engagement.

8. A hydraulic valve, comprising:
a valve housing with a valve bore;
a valve piston axially displaceably received, at least in sections, in the valve bore; and
a setting screw connection coupled to the valve piston at least in an axial direction, wherein the setting screw connection includes:
a setting region;
a setting screw that includes an external thread; and
a setting nut that includes an internal thread;
wherein the internal thread and external thread are configured to be brought into engagement with each other for setting purposes;
wherein at least one of the internal thread and external thread has a cross section which differs from a circular shape;
wherein at least one of the internal thread and external thread is configured to be predominantly elastically deformed via the engagement with the respectively other thread such that at least one of:
the setting screw is secured against rotation in at least the setting region; and
an axial play of the setting screw is prevented in at least the setting region.

9. The hydraulic valve according to claim 8, wherein the setting screw is coupled to the valve piston via a spring.

10. The hydraulic valve according to claim 8, further comprising an electromagnet configured to electromagnetically actuate the hydraulic valve, wherein the setting nut is positioned over a pole tube section of the electromagnet.

11. The hydraulic valve according to claim 10, wherein a housing of the electromagnet is penetrated by the pole tube section.

12. The hydraulic valve according to claim 11, wherein the external thread and the internal thread have substantially similar axial lengths.
